(19) United States
(12) Patent Application Publication
(10) Pub. No.: US 2005/0044853 A1
(43) Pub. Date: Mar. 3, 2005

(54) Ecology system

(76) Inventor: Kazutora Yoshino, Eden Prairie, MN (US)

Correspondence Address: Kazutora Yoshino, 7227 Divinity Ln., Eden Prairie, MN, 55346, US

(21) Appl. No.: 10/653,553

(22) Filed: Sep. 2, 2003

(51) Int. Cl. F03G 6/00

(52) U.S. Cl. 60/641.8

(57) ABSTRACT

Ecosystem that is highly efficient and environmental is shown. Turbo Hydrogen engine with controlled combustion using the recycling of uncombusted gases such as hydrogen and oxygen can be embedded to this ecosystem. Solar energy and wind energy can be used as external energy source. The energy of motion of a vehicle is charged back to usable energy when it reduces the motion.

### FEDERALLY SPONSORED RESEARCH

Not Applicable

### SEQUENCE LISTING OR PROGRAM

Not Applicable

### BACKGROUND OF THE INVENTION

1. Field of the Invention

The invention is directed to a new ecology system that focus on high efficiency, especially to make hydrogen system to be practical.

Hydrogen and oxygen energy release can provide excellent energy efficiency and can produce combustion gases having only emission of water. However, when used as the primary fuel, it is not necessary to be higher efficiency than conventional systems like using gasoline.

2. Description of the Prior Art

Quigley, Jr. (U.S. Pat. No. 3,471,274) discloses a hydrogen combustion engine that uses exhaust pump to remove exhaust gases.

Stowe (U.S. Pat. No. 5,231,954) discloses a hydrogen and oxygen fuel cell for thermal efficiency and for reduction of emissions.

Ovshinsky et al. (U.S. Pat. No. 6,305,442) disclose a hydrogen-based ecosystem. Yet this does not give concrete details to be practical system with high efficiency for market-ready system.

Swain et al. (U.S. Pat. No. 5,603,290) discloses a hydrogen engine with no-abnormal combustion.

The problem remains, however, that overall efficiency of hydrogen system is not maximized to be practical yet.

### SUMMARY OF THE INVENTION

We realized that when to electrolyze water, the efficiency increase dramatically when water is heated and small amount of acid is added. When the coolant water is heated up and used as water that is electrolyzed, it gives us very high efficient system.

The water can be heated up using the sun light if the system is in a building. One can separate light wavelength to short and long ones, and they goes to solar cell and water heating accordingly. This is because solar panel has peak absorbing wavelength and water has different peak heat absorbing wavelength.

Also, by heating up fuel cell using the heat of motor and engine progress the efficiency of electricity.

Also, hydrogen engine can be build as turbo hydrogen engine when the reusable hydrogen and oxygen separated from exhaust water gas are fed back to combustion chamber, cooling down and/or filtering the exhaust gases that have un-combusted hydrogen and oxygen and combusted water gas.

The combination of such high efficient fuel cell and motor is good to make vehicle practical. Optional addition of such turbo hydrogen engine can be an effective hybrid vehicle.

The invention overcomes the problem of efficiency of market compatible vehicle for sale.

### OBJECTS OF THE INVENTION

It is an object of the invention to provide a highly efficient ecosystem, wherein there is least amount of waste in heat together with most ecological in emission.

Another object is to provide a turbo hydrogen engine, and a method of operating the same, which operates successfully for long periods of time under heavy load.

### BRIEF DESCRIPTION OF THE DRAWINGS

Turning now to the drawings:

FIG. 1 is am example diagram of typical ecosystem embodying features of this invention.

FIG. 2 is am example diagram of typical ecology vehicle of this invention.

FIG. 3-1 is am example diagram of typical ecosystem for a house and a vehicle of this invention.

FIG. 3-2 is am example diagram of typical ecosystem for a house of this invention.

FIG. 4 is am example diagram of typical ecosystem priority list of this invention.

FIG. 5 is am example diagram of typical turbo hydrogen engine of this invention.

FIG. 6-1 is am example diagram of typical fuel cell.

FIG. 6-2 is am example diagram of typical fuel cell (PEMFC).

FIG. 7-1 is am example diagram of typical solar panel.

FIG. 7-2 is am example diagram of typical advanced solar panel of this invention.

FIG. 7-3 is am example diagram of typical advanced solar panel with electrolysis system of this invention.

FIG. 8 is am example diagram of typical concept of turbo hydrogen engine system of this invention.

### DESCRIPTION OF SPECIFIC EMBODIMENT

In the description which follows, specific terms and expressions will be used in the interest of clarity. These terms are not intended to define or to limit the scope of the invention, which is defined in the appended claims.

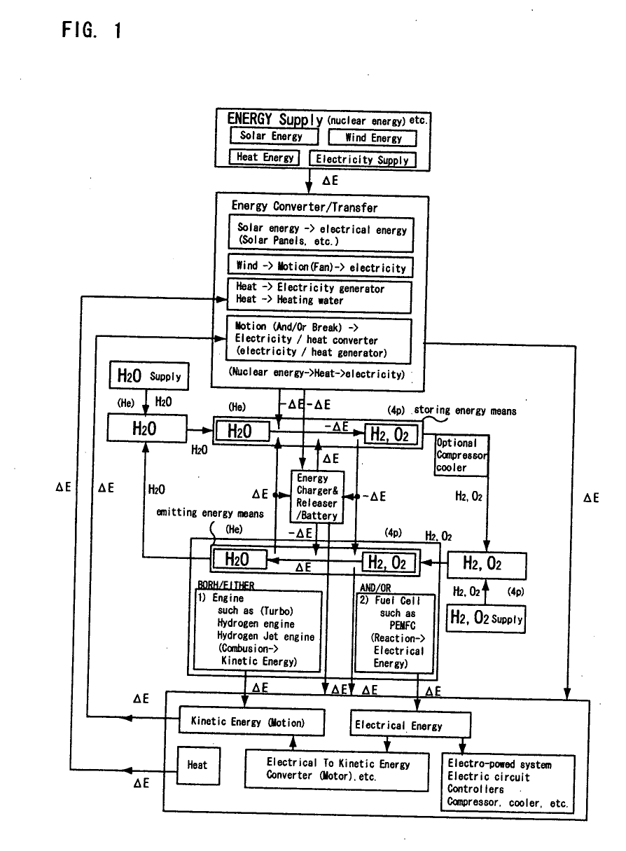

Turning to FIG. 1 of the drawings, the energy supply designates an energy converter and transfer means. This energy is used to store energy. Storing energy means separates or electrolyzes water (plus optionally some acid) to hydrogen and oxygen. Or the energy is converted to electrical charge in battery.

The emitting energy means can be fuel cell and/or hydrogen engine, or any system that releases combination energy of hydrogen and oxygen. Emitting energy means and said storing energy means in which energy can be exchanged with or without battery.

Battery can be used as primal energy storage or secondary to hydrogen & oxygen.

The key here is to re-use the outcome of usage of energy such as heat, motion, to back to system to have high efficient system.

For example, heat of engine and motor can be cooled down by water coolant and this heated water coolant together with exhausted hot water from hydrogen engine can be used in electrolysis chamber to be electrolyzed more efficient than room temperature water.

Also, motion energy of vehicle can be charged back to battery or to hydrogen and oxygen when one uses electricity generator as break.

There are more components such as chemical containers, pipes, energy transferring lines, optional pressure heat managing system means.

Note that nuclear fusion can be used for the same schematics.

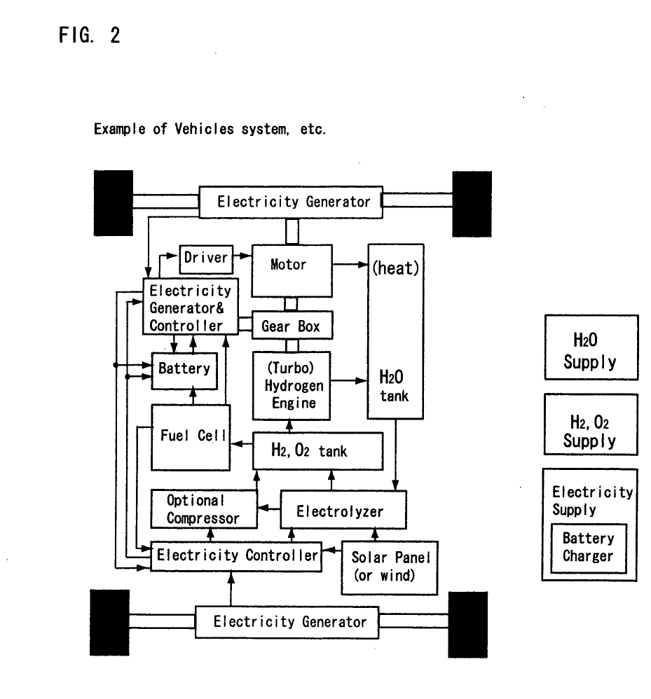

FIG. 2 shows an example of a hydrogen engine and motor vehicle having
turbo hydrogen engine,
motor that is controlled by driver,
optional gear box connecting said hydrogen engine and said motor,
electricity generator and controller that generate electrical energy using the power of hydrogen engine in case of necessity,
battery that charges and release electrical energy to electricity controller,
fuel cell that provides electricity to battery and electrical components using the combination energy of hydrogen and oxygen,
electrolysis chamber in which water is electrolyzed into said hydrogen and said oxygen,
optional compressor that compresses said hydrogen and said oxygen into hydrogen tank and oxygen tank or hydrogen-oxygen tank,
water tank that provide said water to said water electrolysis chamber, optional heating and cooling system that heat up said water by cooling said hydrogen engine and said motor,
electricity generator that charges the energy of motion to electrical energy and charge to said battery or send energy to said electrolysis chamber to generate said hydrogen and said oxygen when break of vehicle is used or in case of necessity of electricity,
solar panels that produce electrical energy from sun light,
electricity controller that controls the flows of electricity to or from electrical components such as said battery, said fuel cell, said driver, said electrolysis chamber, said solar panel, said electricity generator.

Basically, a car runs by the energy of hydrogen and oxygen with high efficiency. Because the motional energy is charged back to battery with high efficiency by electricity generator as break, small amount of supplemental energy is necessary. In this diagram, solar panel and combinational energy of hydrogen and oxygen are used to supply such energy. In the excess of energy, it try to convert water to hydrogen and oxygen.

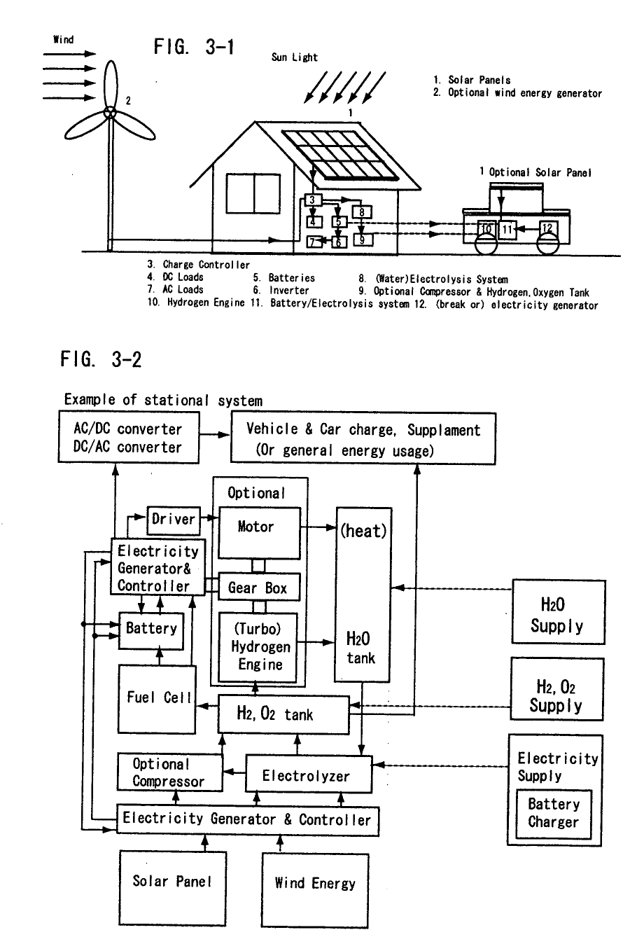

FIG. 3-1 is am example diagram of typical ecosystem for a house and a vehicle of this invention.

FIG. 3-2 shows an example of a hydrogen system having
optionally hydrogen engine or turbo hydrogen engine,
optional motor that is controlled by driver,
optional gear box connecting said hydrogen engine and said motor,
electricity generator and controller that generate electrical energy using the power of hydrogen engine in case of necessity,
battery that charges and release electrical energy to electricity controller,
fuel cell that provides electricity to battery and electrical components using the combination energy of hydrogen and oxygen,
electrolysis chamber in which water is electrolyzed into said hydrogen and said oxygen,
optional compressor that compresses said hydrogen and said oxygen into hydrogen tank and oxygen tank or hydrogen-oxygen tank,
water tank that provide said water to said water electrolysis chamber, optional heating and cooling system that heat up said water by cooling said hydrogen engine and said motor,
solar panels that produce electrical energy from sun light, advanced solar panels means,
optionally wind energy generator such as fans with electricity generator,
electricity controller that controls the flows of electricity to or from electrical components such as said battery, said fuel cell, said driver, said electrolysis chamber, said solar panel, said electricity generator.
Alternative current and direct current converter, and direct current and alternative current converter,

Basically the same thing except this one is designed for home, industrial building. Solar energy and wind energy is the main energy supply. Also, the electricity, hydrogen and oxygen created here can be transferred to vehicles as well. Advanced solar panel can be used on the top of roofs.

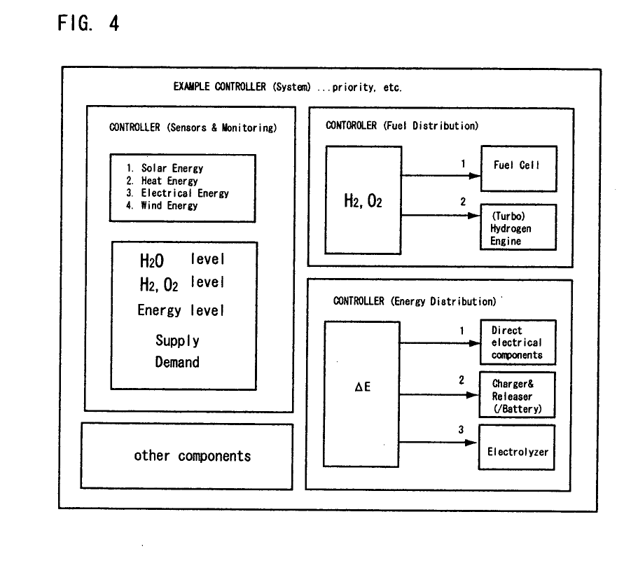

FIG. 4 shows the diagram of example priority list of controllers so that each controller can decide where to navigate energy and hydrogen and oxygen.

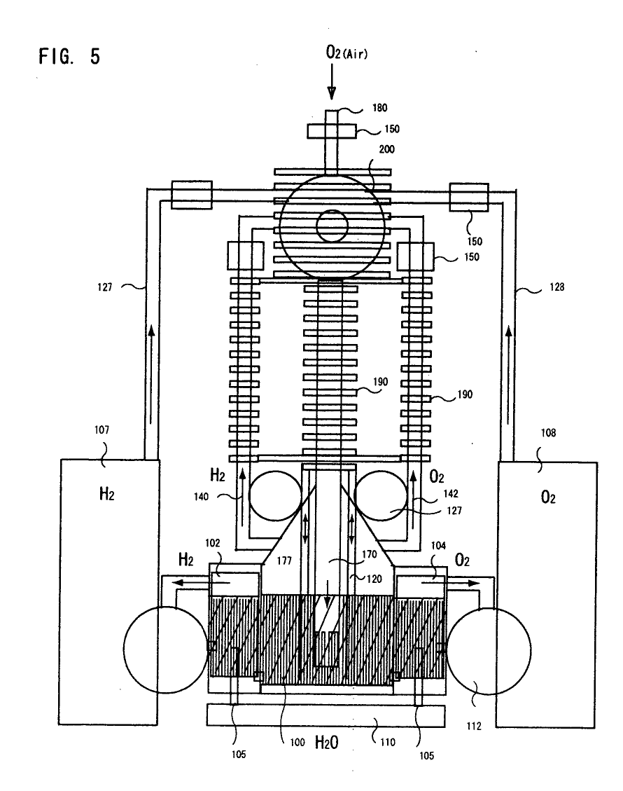

FIG. 5 shows the diagram of example turbo hydrogen engine.

It has inlet for fuel gases means, outlet for exhausted gases means, a combustion chamber means connected to said inlet and said outlet,

feedback system means that reverses said fuel gases means of said exhausted gases from said combustion chamber in separation chamber means in which said exhausted gases is separated to reusable gases from said fuel gases means for the purpose of high efficiency, optionally together with water electrolysis system means, optional pressure and heat managing system, compressors, hydrogen tank, oxygen tank, fuel cells, and controlling system.

Basically, water (100) is electrolyzed to hydrogen (102) and oxygen (104), and they are compressed (112) to tanks (107 & 108). The electrodes (105) can be metal like platinum. Those gases are put together in the combustion chamber (200) to be combusted to make water gas. The un-combusted hydrogen and oxygen and water gas (170) is sent to water (100) while cooled down by the coolant water (190). When those gases (170) passes the water chamber (100), only water gas can become liquid and hydrogen and oxygen goes up to the top of chamber (177). (These gases can be re-compressed by compressor.) Through pipes for hydrogen and oxygen (140 & 142), it goes back to combustion chamber (200). The valves and pressure control (150) controls the flow of each gases. If necessary, oxygen from air can be taken. Water coolant can be the same water (100) using compressor (127) so that the heat from engine (combustion and pipe) would be used for the efficiency of electrolysis chamber (177, 102, 104 and 107).

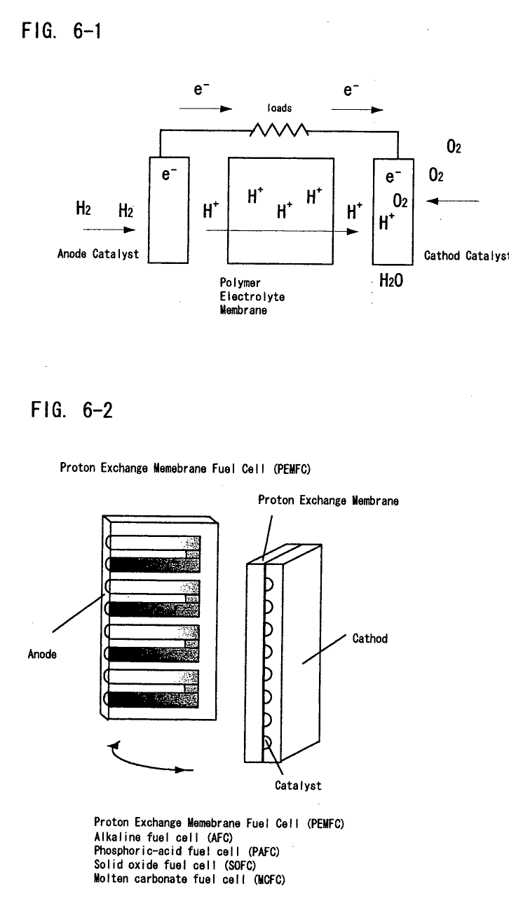

FIG. 6-1 shows the diagram of concept of fuel cells.

FIG. 6-2 shows the diagram of proton exchange membrane fuel cell. Note, there are more fuel cells such as alkaline fuel cell, phosphoric-acid fuel cell, solid oxide fuel cell, molten carbonate fuel cell.

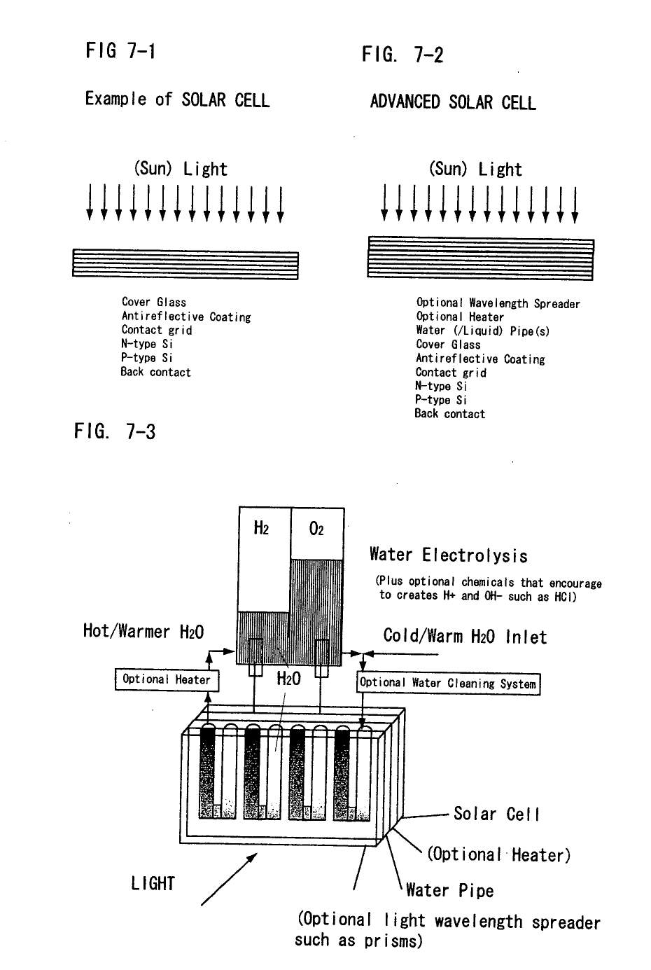

FIG. 7-1 shows the diagram of standard solar cell

FIG. 7-2 shows the diagram of advance solar cell. This has water pipe to be heated on solar cells.

FIG. 7-3 shows the diagram of combination of advanced solar cell and electrolysis chamber.

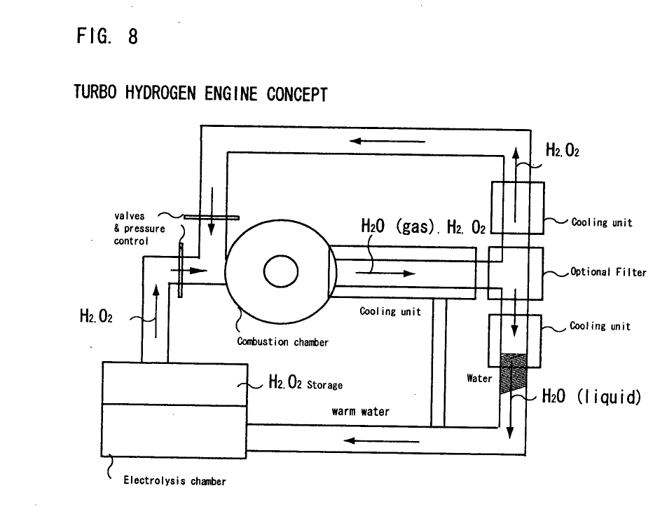

FIG. 8 shows the diagram of concept of hydrogen & oxygen and water separating system. Basically, cooled water gas become liquid water and hydrogen and oxygen goes up to be reused for turbo engine.

1. In an ecology system, said system having energy supply means supplying energy to energy converter and transfer means,
storing energy means that separate or electrolyze original component means to separated components means using said energy converted and transferred by said energy converter and transfer means,
emitting energy means and said storing energy means in which energy can be exchanged with or without energy charger & releaser means,
said energy charger and releaser means in which energy from said energy converter and transfer means is charged and released, in which energy from said emitting energy means and said storing energy means is charged and released,
components containers, pipes, energy transferring lines,
optional pressure heat managing system means.

2. The ecology system defined in claim 1, wherein said energy supply means is composed of the group of combinations comprising
solar energy, wind energy, heat energy, electrical energy, nuclear energy, and external electricity supply.

3. The ecology system defined in claim 1, wherein said energy converter and transfer means is composed of the group of combinations comprising
Energy converter of solar energy to electrical energy, solar panels, solar thermal electricity generator,
Energy converter of wind energy to motion to electricity, wind fan electricity generator,
Energy converter of heat energy to electricity, heater of water, heater of said chemical components, and
Energy converter of motion to electricity, electricity generator, electromagnetic electricity generator, motor.

4. The ecology system defined in claim 1, wherein said storing energy means is composed of
Particles separating system, electrolysis system comprising
Electrode means comprising the group of combinations comprising inorganic components such as platinum, metals, and organic components, and
Components separating chambers that electrolyze said original components means to generate said separated chemical component means, and
Optionally, heating system of said original components.

5. The ecology system defined in claim 1, wherein said emitting energy means is composed of the group of combinations comprising
Fuel cell such as
Proton exchange membrane fuel Cell,
Alkaline fuel cell,
Phosphoric-acid fuel cell,
Solid oxide fuel cell,
Molten carbonate fuel cell, and
Hydrogen-oxygen fuel cell.
Hydrogen engine such as
hydrogen engine, turbo hydrogen engine, hydrogen jet engine, turbo hydrogen jet engine, nuclear fission engine, nuclear fusion engine, plasma engine,
optionally heat transferring system to heat up fuel cell, heat transferring system to carry the heat from engine or motor to fuel cell.

6. The ecology system defined in claim 1, wherein said energy charger and releaser means is composed of the group of combinations comprising
Battery, chemical battery, secondary battery, dry cell battery, mercury battery, lead storage battery, nickel-cadmium battery, fuel cells, aluminum-air battery, superconductor energy charger and releaser, and electromagnetic energy charger and releaser.

7. The ecology system defined in claim 1, wherein said original component means is composed of the group of combinations comprising
Water, chemical components that can be electrolyzed, organic chemical components, ethanol, ethyl alcohol, methyl alcohol, heptanes, acids to increase the amount of ions of original chemical components such as hydrochloride acid, nitric acid, perchloride acid, sulfuric acid, and
Helium, resultant components of nuclear fusion.

8. The ecology system defined in claim 1, wherein said separated components means is composed of the group of combinations comprising
Hydrogen, oxygen, chemical components that is results of electrolysis of said original components,
protons, deuterium, tritium, helum.

9. The ecology system defined in claim 1, wherein said pressure and heat managing system means is composed of the group of combinations comprising
Pipes, coolant such as water, hydrogen-oxygen and water separating filter, hydrogen-oxygen and water separating chamber,
optional compressors that compress said separated component means

10. In a turbo hydrogen engine, said turbo hydrogen engine is composed of
hydrogen engine having inlet for fuel gases means, outlet for exhausted gases means, a combustion chamber means connected to said inlet and said outlet,
feedback system means that reverses said fuel gases means of said exhausted gases from said combustion chamber in separation chamber means in which said exhausted gases is separated to reusable gases from said fuel gases means for the purpose of high efficiency,
optionally together with water electrolysis system means, optional pressure and heat managing system, compressors, hydrogen tank, oxygen tank, fuel cells, and controlling system.

11. The hydrogen engine defined in claim 10, wherein said fuel gas means is comprising a group selected from the combination of components comprising hydrogen, oxygen, air, gasoline, water, inorganic chemical components, organic chemical components, ethyl alcohol, methyl alcohol, heptanes, and chemical components that combust.

12. The hydrogen engine defined in claim 10, wherein said combustion chamber means is comprising of a chamber with a piston connected to said cylinder for moving up and down between upper and lower limits within said cylinder, said piston having rings with piston volume between them, said piston rings, a shaft and proper components that make said piston to make reciprocating motion, thereby the rotation of said shaft.

13. The hydrogen engine defined in claim 10, wherein said combustion chamber means is composed of a chamber with a rotational mechanism, rotary engine system.

14. The hydrogen engine defined in claim 10, wherein said combustion chamber means is composed of a chamber with a hydrogen jet engine.

15. The hydrogen engine defined in claim 10, wherein said separation chamber means is composed of
cooling system of said exhausted gases, pipes that separates reusable gases such as hydrogen and oxygen from liquid water using said cooling system and gravity,

16. The hydrogen engine defined in claim 10, wherein said separation chamber means is composed of
separating filter that separates reusable gases such as hydrogen and oxygen from liquid water using liquid water separating filter.

17. In a hydrogen engine and motor vehicle, said hydrogen engine and motor vehicle having
optionally hydrogen engine or turbo hydrogen engine,
motor that is controlled by driver,
optional gear box connecting said hydrogen engine and said motor,
electricity generator and controller that generate electrical energy using the power of hydrogen engine in case of necessity,
battery that charges and release electrical energy to electricity controller,
fuel cell that provides electricity to battery and electrical components using the combination energy of hydrogen and oxygen,
electrolysis chamber in which water is electrolyzed into said hydrogen and said oxygen,
optional compressor that compresses said hydrogen and said oxygen into hydrogen tank and oxygen tank or hydrogen-oxygen tank,
water tank that provide said water to said water electrolysis chamber, optional heating and cooling system that heat up said water by cooling said hydrogen engine and said motor,
electricity generator that charges the energy of motion to electrical energy and charge to said battery or send energy to said electrolysis chamber to generate said hydrogen and said oxygen when break of vehicle is used or in case of necessity of electricity,
solar panels that produce electrical energy from sun light,
electricity controller that controls the flows of electricity to or from electrical components such as said battery, said fuel cell, said driver, said electrolysis chamber, said solar panel, said electricity generator.

18. In a hydrogen system, said hydrogen system having
optionally hydrogen engine or turbo hydrogen engine,
optional motor that is controlled by driver,
optional gear box connecting said hydrogen engine and said motor,
electricity generator and controller that generate electrical energy using the power of hydrogen engine in case of necessity,
battery that charges and release electrical energy to electricity controller,
fuel cell that provides electricity to battery and electrical components using the combination energy of hydrogen and oxygen,
electrolysis chamber in which water is electrolyzed into said hydrogen and said oxygen,
optional compressor that compresses said hydrogen and said oxygen into hydrogen tank and oxygen tank or hydrogen-oxygen tank,
water tank that provide said water to said water electrolysis chamber, optional heating and cooling system that heat up said water by cooling said hydrogen engine and said motor,
solar panels that produce electrical energy from sun light, advanced solar panels means,
optionally wind energy generator such as fans with electricity generator,
electricity controller that controls the flows of electricity to or from electrical components such as said battery, said fuel cell, said driver, said electrolysis chamber, said solar panel, said electricity generator.
Alternative current and direct current converter, and direct current and alternative current converter.

19. The hydrogen system defined in claim 18, wherein said advanced solar panel means is composed of
water in water heating pipes such as standard pipes and clear prism-like shape on solar cell means to receive light to be heated up efficiently,
optionally, heater to heat water in case of small intensity of light, and light wavelength spreading prisms made of glasses, plastics or water and water pipe to spread out the wavelength to shorter wavelength and longer wavelength, where one goes to solar cells and the other goes to water pipes to have higher efficiency to energy absorption.

20. The advanced solar system defined in claim 19, wherein said solar cell means is composed of
cover glass, antireflective coating, contact grid, and back contact, cells that can be made of n-type Si, p-type Si, mono-crystal, multiple-crystal, amolphas, GaAs, CdS, CdTe, CulnGaSe2.
